(19) United States
(12) Patent Application Publication
(10) Pub. No.: US 2018/0343296 A1
(43) Pub. Date: Nov. 29, 2018

(54) WEB-BASED SERVICES ON A SPECTROMETER

(71) Applicant: Ocean Optics, Inc., Largo, FL (US)

(72) Inventor: Marc Floyd, Oviedo, FL (US)

(21) Appl. No.: 15/980,830

(22) Filed: May 16, 2018

Related U.S. Application Data
(60) Provisional application No. 62/510,307, filed on May 24, 2017.

(51) Int. Cl. H04L 29/08

(52) U.S. Cl. CPC H04L 67/02; G06F 9/547; H04L 67/12

(57) ABSTRACT

A web-based services on a spectrometer system that enables a web-based server to provide multiple standard protocols including, but not limited to, Hyper Text Transfer Markup (HTTP) and Secure (HTTPS) as well as File Transfer Protocol (FTP) thus allowing native administrative and management applications to run on the spectrometer system and, by the use of standard interfaces, to connect to and send and retrieve information directly between the spectrometer and client devices via a web-based server is disclosed.

### CROSS-REFERENCE TO RELATED APPLICATION

The present application claims the benefit of previously filed co-pending Provisional Patent Application, Ser. No. 62/510,307, filed on May 24, 2017.

### FIELD OF THE INVENTION

The device of this disclosure belongs to the field of spectrometer systems. More specifically it is a spectrometer system for providing administrative and management application services directly from a spectrometer to client devices via a web-based server.

### BACKGROUND OF THE INVENTION

Spectrometers with several buses capable of communicating to client devices such as PCs are now commercially available and these spectrometers also now include the addition of an embedded Operating System (OS). With the addition of an embedded OS as part of the overall spectrometer solution, it is now possible to provide services that include administrative and management applications directly to client devices from the spectrometer via a web-based server.

Thus there is a need to have web-based services on a spectrometer system as disclosed herein.

### BRIEF SUMMARY OF THE INVENTION

The web-based services on a spectrometer system of this disclosure enables a web-based server to provide multiple standard protocols including, but not limited to, Hyper Text Transfer Markup (HTTP) and Secure (HTTPS) as well as File Transfer Protocol (FTP). By doing this, native administrative and management applications can run on the spectrometer and standard interfaces can be used to connect to client devices allowing those devices to send and retrieve information directly to and from the spectrometer via a web-based server.

### BRIEF DESCRIPTION OF THE DRAWINGS

For a fuller understanding of the nature and objects of the invention, reference should be made to the following detailed description, taken in connection with the accompanying drawings, in which:

FIG. 1 shows a typical OSI Network Model used by the preferred embodiment of the web-based services on a spectrometer system.

### DESCRIPTION OF THE PREFERRED EMBODIMENT

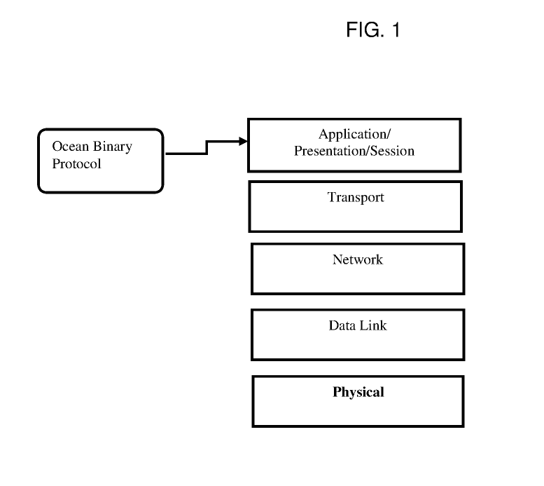

The web-based services on a spectrometer system protocol of this disclosure is inserted in the Application or Presentation layer of the OS as depicted by the OSI Network Model shown in FIG. 1. Network models such as the one shown in FIG. 1 are well known by those skilled in the art.

With the addition of an embedded operating system as part of the overall spectrometer solution along with a web-based server, it is now possible to include services that are unique for providing administrative and management applications directly from the spectrometer to client devices via the web-based server. The web-based server can provide multiple standard protocols including, but not limited to, Hyper Text Transfer Markup (HTTP) and Secure (HTTPS) as well as File Transfer Protocol (FTP). By doing this, native administrative and management applications can run on the spectrometer and standard interfaces can connect to client devices allowing them to send and retrieve information directly to and from the spectrometer via a web-based server.

In addition to this, because the spectrometer system is utilizing standard World Wide Web (WWW) protocols, the client device may also be connected to the Internet through standard Wide Area Network (WAN) configurations, which then lets the client device gain access remotely from anywhere where internet access is possible. In this way HTTPS protocol is used to allow these remote users to gain access to and transfer data from the spectrometer.

Also other Representative State Transfer (REST) architectures are implemented on the spectrometer system based on the web-based services provided by the embedded environment. For instance, by the use of Object based storage protocols (i.e. Swift), the spectrometer serves as a private cloud server to further allow for easy transfer of data to and from the spectrometer system to client devices via protocols that are used by multiple mobile application operating systems (such as IOS and MacOS with Swift).

Since certain changes may be made in the above described web-based services on a spectrometer system without departing from the scope of the invention herein involved, it is intended that all matter contained in the description thereof or shown in the accompanying FIGURE shall be interpreted as illustrative and not in a limiting sense.

What is claimed is:

1. A spectrometer system including web-based services comprising:
a spectrometer system with embedded operating system software;
web-based services installed into an application layer of said software operating system; and,
said spectrometer system having multiple standard protocol interfaces provided from a web-based server.

2. The spectrometer system of claim 1 wherein said standard protocol interfaces include one or more of Hyper Text Transfer Markup (HTTP), Secure (HTTPS), or File Transfer Protocol (FTP) protocols and said web-based services are native administrative and management applications.

3. The spectrometer system of claim 2 further comprising:
said spectrometer system connected to a user's device through standard Wide Area Network (WAN) configurations and running native administrative and management applications on said spectrometer and said standard protocol interfaces connecting a user's device to, retrieving information from, and supplying information to said spectrometer.

4. The spectrometer system of claim 3 further comprising:
Representative State Transfer (REST) architectures installed on said spectrometer system in accordance with said web-based services of said embedded software operating system.
